(19) United States
(12) Patent Application Publication
(10) Pub. No.: US 2010/0325221 A1
(43) Pub. Date: Dec. 23, 2010

(54) METHOD FOR INSERTING MULTIMEDIA CONTENT INTO A COMPUTER COMMUNICATION BY INSTANT MESSAGING

(76) Inventors: Francis Cohen, Maisons Alfort (FR); Stéphane Rocchiccioli, Paris (FR)

Correspondence Address: GREER, BURNS & CRAIN, 300 S WACKER DR, 25TH FLOOR, CHICAGO, IL, 60606, US

(21) Appl. No.: 12/528,245

(22) PCT Filed: Feb. 18, 2008
(86) PCT No.: PCT/FR08/50269

§ 371 Date: Aug. 21, 2009

(30) Foreign Application Priority Data
Feb. 23, 2007 (FR) 0701321

(51) Int. Cl. G06F 15/16

(52) U.S. Cl. 709/206

(57) ABSTRACT

A method for the insertion of a multimedia content into a computerized communication by an instant messaging service between a first session executed on a first computerized device and at least one second session executed on a second computerized device, the method including on the one hand, prior to the insertion of the multimedia content, the following steps: the multimedia content is constituted by at least one instant messaging user; the multimedia content is stored in a third computerized device, and on the other hand, during communication, the following steps: the execution of the content is activated by the first session; the multimedia content is automatically executed, following the activation, based on data received from the third computerized device.

The present invention relates to a method for the insertion of a multimedia content into a computerized conversation by instant messaging between a first session executed by a first computerized device and a second session executed by a second computerized device. It also relates to a system implementing the method according to the invention.

Numerous instant messaging services currently exist, such as Yahoo !® Messenger and Windows Live™ Messenger. These instant messaging services make it possible to carry out a computerized communication by real-time exchange of text-based messages. Generally, these messaging systems use a two-part window, one part for the local user (or sender) to compose messages and the other for the display of the conversation. In the sender part, the local user inputs text, which is sent in the form of a message as soon as he hits the “Enter” key. The message then automatically displays in the window of his correspondent's messaging system, in the part corresponding to messages from his correspondent(s). This communication by text messages can optionally be complemented by a continuous oral or even visual communication using devices such as a microphone and a webcam. It is possible to insert graphical elements, such as emoticons (“smileys” or “winks”) consisting of small graphical animations, into the text messages.

However, these graphical elements are not very sophisticated and are restricted to those offered by the instant messaging service.

During such an instant messaging conversation, it can be advantageous for a user to be able to use more sophisticated or more personal multimedia content without being restricted to elements provided in advance by the instant messaging service.

A purpose of the invention is to allow a communication by instant messaging that is richer, more flexible, more varied or more personalized.

Another purpose of the invention is to make it possible to offer such a functionality to the users of currently existing instant messaging services, within the framework of the service that they already use.

The invention thus proposes a method for inserting a multimedia content into a computerized communication by an instant messaging service between a first session executed on a first computerized device and at least one second session executed on a second computerized device, this method comprising

on the one hand, the following steps prior to the insertion of the multimedia content:
multimedia content is constituted by at least one instant messaging user;
the multimedia content is stored in a third computerized device and, on the other hand, the following steps during the communication:
execution of the content is activated by the first session;

the multimedia content is automatically executed, following the activation, based on data received from the third computerized device.

By multimedia content is understood an audio or video content or an audio and video content.

Constituting a multimedia content can be done for example by creating multimedia content using equipment such as a camcorder, microphone, multimedia software or similar equipment. It can also be done by modifying existing multimedia content, by adding, deleting or modifying all or some of such content.

Using the method according to the invention, it is possible to use more sophisticated and more personal multimedia as desired, during a computerized communication by instant messaging.

This content includes in particular small videos of a few seconds or more, called “EmoVid”, which the user can incorporate into the text of his message or send in parallel at the time he wishes. This emovid can be received and executed automatically by a correspondent already equipped with the corresponding insertion software and possibly a subscribed to such a service. When this emovid is sent or received, its content is executed in a substantially simultaneous fashion on the sender's screen and on that of the recipient.

As will be described below in greater detail, this emovid can also be received by a correspondent having a standard version of instant messaging only, in the form of a hypertext link in a text message which is automatically displayed, and which will allow him to display instantly and easily the content of the emovid that has been sent to him.

Moreover, the method according to the invention makes it possible to use multimedia content prepared by users of the instant messaging service during a computerized communication by this service. Thus, the user is not restricted to graphical content that is pre-provided by the messaging service.

Thus the user is free to create multimedia content himself that he desires to use during the communication, to modify multimedia content existing on the third computerized device, to make the multimedia content that he has created available to other users. Thus the method according to the invention makes it possible for these users to carry out a communication by instant messaging that is more sophisticated, freer, more personal and richer than the computerized communications of the current instant messaging services.

It is for example possible for a user to use as inserted content a video sequence showing his children waving, or any other scene, optionally modified by him with text or a recorded sound or drawings. This content can for example be used to accompany a message containing the text “hello” or “goodbye”, or any other meaning that he considers appropriate in relation to the multimedia content that he has prepared or selected.

Moreover, the method according to the invention makes it possible to accelerate the insertion of multimedia content into the computerized communication, by proposing automatic activation of the insertion of the inserted content, thus reducing the number of operations to be carried out by the user.

Advantageously, automatic execution of the multimedia content can take place in the first computerized equipment at the level of the first session. Once the content to be inserted into the communication has been chosen and activated in the first session, for example by the user of the first session, the content is automatically executed in the first session using means of execution of the multimedia content, such as a suitable multimedia player software of a known type.

In a preferred embodiment of the method according to the invention, the automatic execution of the multimedia content takes place in the second computer equipment. In this preferred embodiment, after the step of activating the execution of the multimedia content, the latter is executed by the first computerized device and by the second computerized device such that the user of the first session and the user of the second session see (or hear) the multimedia content in parallel, for example in a substantially simultaneous fashion. In this preferred embodiment, the multimedia content is sent, from the third device on which it is stored, on the one hand to the first device and on the other hand to the second device. Data initiating the execution of the inserted multimedia content can be sent to the second device either by the first device, or by the third device.

A second embodiment of the method according to the invention, capable of being combined with the first, can comprise sending, by the first computerized device to the second computerized device, initiating data for execution of the multimedia content. These execution initiation data comprise a data item of the Uniform Resource Locator (URL) type, linking to an internet page, for example of the World Wide Web type, provided for the execution of the multimedia content. These execution initiation data can be sent in the form of a text message, and appear in the display means used for the communication. When the second device receives the execution initiation data, the internet page can be opened manually by the user, who can for example activate the opening of the internet page by simply clicking on the URL-type data item which is displayed in the form of a hypertext link in a text message in the display or communication window of the instant messaging service.

In this second embodiment, the multimedia content can also be executed automatically by the second computerized device when it accesses the internet page. Execution of the content can be done either directly in the internet page or in a multimedia player external to the internet page and installed on the second computerized device.

Advantageously, the method according to the invention can comprise moreover an insertion into at least one message within the data communication related to the multimedia content and/or to the execution of the multimedia content. These data can be displayed over the dialogue window of the instant messaging service and give the user information on the multimedia content, its location or the execution of the multimedia content. These data can also include the execution initiation data of the multimedia content allowing the first and second computerized device to enter into communication with the third computerized device, to download the multimedia content from the third device and to execute it using a communications protocol. The data can for example be inserted as “payload” (i.e. carried without being processed) in the messages or the frames exchanged during the computerized communication.

Moreover the method according to the invention can comprise a selection of multimedia content by a user in the first equipment, from a plurality of multimedia contents. The plurality of multimedia contents can be offered by the third device, for example in the form of a list of contents displayed in a display window in or beside the dialogue window or the window of the messaging service, each of the contents being optionally accompanied by descriptive information. Moreover, the plurality of contents can be offered in the form of a classification either by theme, or according to the use of the different contents, for example the ten most used contents, or the contents recently added, or also the contents created by a particular user.

The method according to the invention can comprise, according to an advantageous feature, an automatic offer of at least one multimedia content to be inserted in the communication, chosen according to an analysis of the content of at least one message during the current communication and/or at least one previous communication.

Thus, the method according to the invention can comprise textual analysis of the content of the text messages of the current communication or an analysis of the multimedia content previously inserted within the framework of the current communication. This analysis of the current communication will activate the offer of one or more multimedia contents to be inserted in this same communication, which will be chosen automatically according to the analysis of the content of at least one previous communication, carried out either by the same user or by at least one other user. The analysis of the content of a message or the choice of contents to be offered can comprise in particular a statistical analysis.

The method according to the invention comprises a use of different statistical algorithms, without functionally changing the textual analysis and the activation of the offer of content following this analysis. Thus, an algorithm can be substituted for another which is considered to be less effective. Thus, the method makes it possible to use any textual analysis algorithm, the input data of which are:
the history of the current instant messaging conversation in which a user A is taking part;
the logs of an instant messaging discussion by user A with users B, C, D, etc.
the logs of instant messaging discussion carried out by users other than user A, and
the descriptive metadata characteristics and characteristics describing a given multimedia content (title, author, tags, commentary, note)
   and the output data of which are a classification of offered multimedia content from the most relevant to the least relevant at a time t of a current instant messaging discussion.

In the present application, by discussion log is meant the log file, or more simply log, containing all events affecting or relating to the discussion carried out by instant messaging. Generally dated and classified in chronological order, the latter allow step-by-step analysis of the internal activity of the process and its interactions with its environment.

The following is a simple example to illustrate an automatic offer of multimedia content according to the analysis of the content of a message: when a user A sends a text message containing the word “Hello” to a user B, the method according to the invention can make an offer to user B of multimedia content corresponding to “Hello, are you alright?” to insert into his conversation with user A, if it has been determined by analysis of previous instant messaging conversations that the response to a “Hello” text message corresponds in a majority of cases to “Hello, are you alright?”.

The analysis of the message content of an instant messaging conversation can be done:
either at the level of the first and the second computerized device by an analysis module which, according to the analysis, chooses at least one content stored on the third device in order to offer it to the user. In this case the analysis results and the actions of the user following the offer of content are sent to the third or a fourth computerized device to be stored there for subsequent use.
or at the level of a third or a fourth computerized device, through which the messages of the conversation pass. These messages are analyzed there and the third or the fourth device offers a multimedia content to be inserted into the conversation and stores the results of the analysis and the actions of the user in response to the offer, for subsequent use.

Each instant messaging conversation can be analyzed automatically, and trends or typical responses to typical questions or also typical phrases in typical situations can be identified. When, subsequently, a typical question or a typical situation or a trend is detected as similar or corresponding, the method according to the invention offers at least one content to be inserted appropriate to this detection.

In an advantageous version of the invention, the method according to the invention can comprise moreover an identification of a type of instant messaging service, by analysis of the technical data of the communication. In fact, during the establishment of the computerized communication or during the computerized communication itself, the method according to the invention makes it possible to determine the type of messaging service (namely for example Windows® Live™ Messenger, Yahoo® Messenger, etc.) by analyzing for example:
the protocol used for exchange of the data of the computerized communication,
the content of the data packets exchanged, the data processing resources (files, processes, etc) used by the computerized communication, or
the events taking place during the computerized communication.

Advantageously, the method according to the invention can be implemented for the insertion of a multimedia content into a computerized communication by an instant messaging service between the first session executed on the first computerized device and several other sessions each executed on a computerized device.

The invention also relates to a method of instant messaging implementing a method of insertion of a multimedia content such as described above.

According to a further aspect of the invention, there is proposed a system for the insertion of a multimedia content in a computerized communication by instant messaging between a first session executed on a first computerized device and a second session executed on a second computerized device, the system comprising:
means for constituting the multimedia content by at least one instant messaging user;
means for storing the multimedia content in a third computerized device,
computerized means for activating by the first session, during the communication, the execution of the multimedia content; and
means for automatically executing the multimedia content, following the activation on the basis of data received from the third computerized device.

The system according to the invention comprises means of analysis provided for analyzing the content of at least one message within the communication in order to choose at least one multimedia content according to said content. These means of analysis can comprise means of textual analysis provided to perform a textual analysis of the content of a message during a written conversation and means of statistical analysis making it possible to carry out a statistical analysis of the content of the messages.

Advantageously, the system according to the invention can comprise moreover means of detection provided to identify the type of instant messaging service. These means can be computerized means presented in the form of a module allowing analysis, on the one hand of the technical data exchanged between the first and the second computerized device and on the other hand between the first (or the second) computerized device and the server of the instant messaging service within the framework of the computerized communication as well as the data relating to the exchanges of the computerized messaging system with the other components and resources within the computerized device concerned.

Moreover, the system according to the invention can comprise moreover means of displaying, at least by the first computerized device, a list of multimedia contents previously stored on the third equipment. These display means can comprise means of displaying a window comprising the multimedia contents optionally classified according to different categories or according to a statistical criterion.

According to an embodiment, the system according to the invention can be independent of the instant messaging system and comprise means of exchange of data with the instant messaging system. Thus the system according to the invention can operate with existing messaging systems, complementing their functionalities.

According to another embodiment, the system according to the invention can be integrated into the instant messaging system.

Other advantages and features will appear upon examination of the detailed description of an embodiment that is no way limitative and of the attached drawings in which

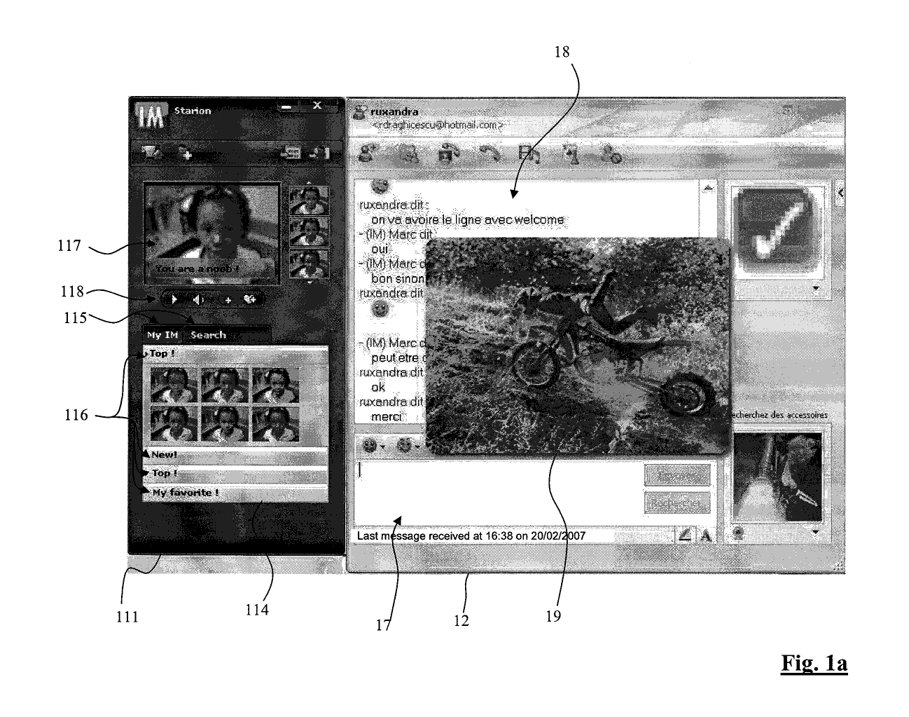

FIG. 1 is a non-exhaustive diagrammatic representation of the software elements involved at the level of a user's computerized device during an insertion, according to the invention, of multimedia content into a computerized communication by instant messaging;

FIG. 1a shows the user interfaces for the insertion of a multimedia content according to the invention;

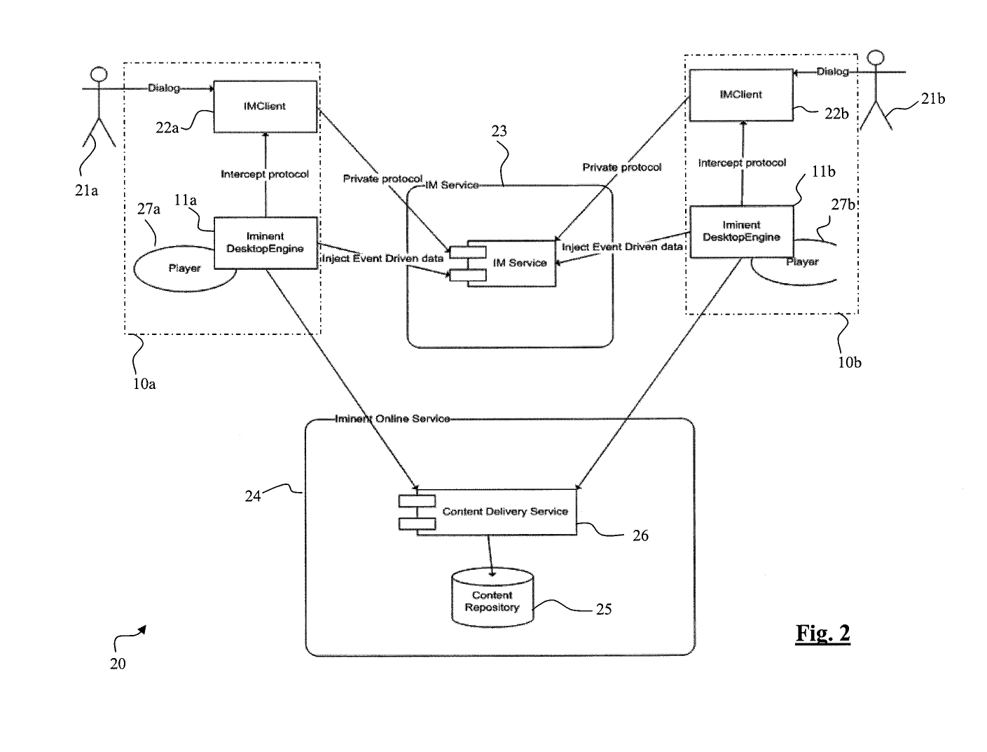

FIG. 2 is a diagrammatic representation of a preferred embodiment of the invention;

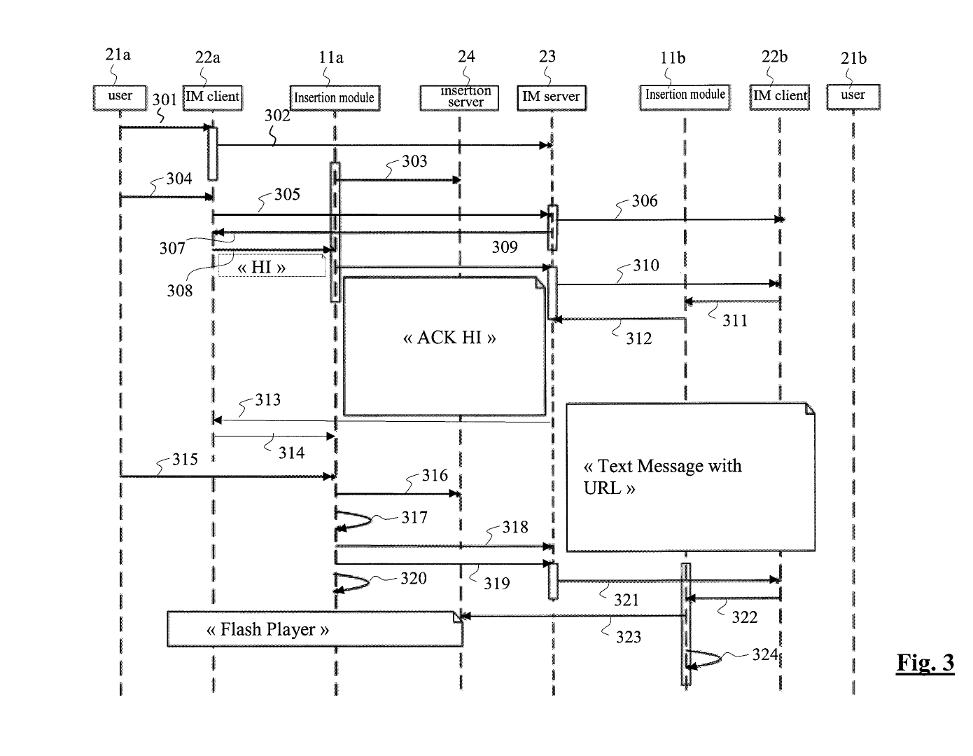

FIG. 3 is a diagrammatic representation in the form of a time diagram of a sequence of insertion of multimedia content in the preferred embodiment;

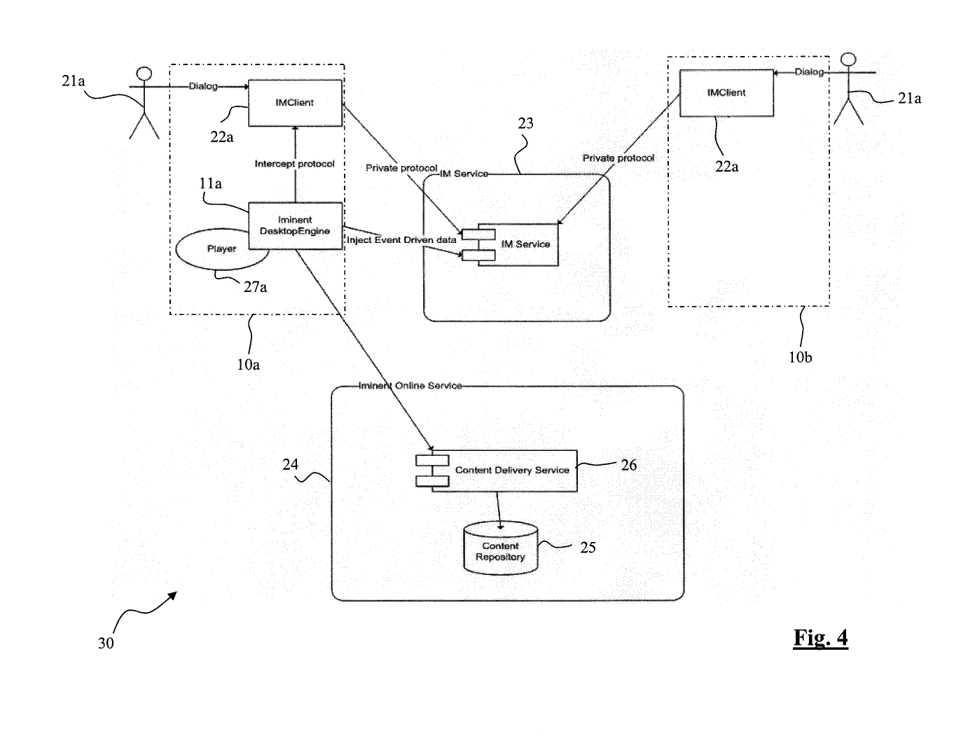

FIG. 4 is a diagrammatic representation of a second embodiment of the invention; and

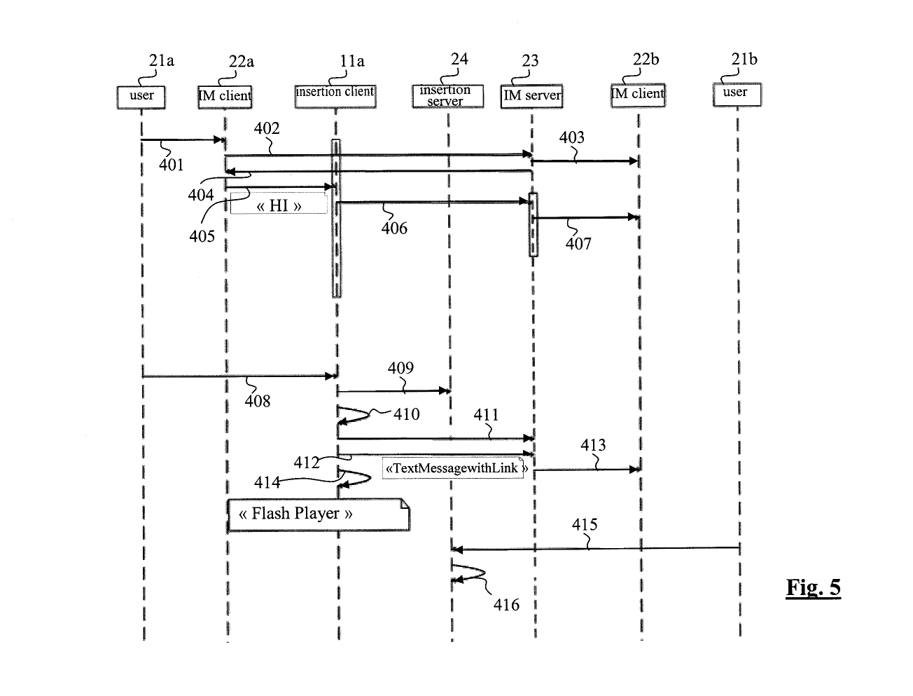

FIG. 5 is a diagrammatic representation in the form of a time diagram of a sequence of insertion of multimedia content in the second embodiment.

The examples which will be detailed below concern an insertion of multimedia content that will be denoted “emovid” in the remainder of this description, into a computerized communication by instant messaging (IM). In these examples, the system according to the invention comprises a first software module executed by the user's computerized device and a second module executed by the third computerized device where the emovids are stored.

FIG. 1 is a non-exhaustive diagrammatic representation of the elements involved at the level of a user's computerized device (10) during an insertion of an emovid into a computerized communication by instant messaging. The user's computerized device 10 comprises a module for insertion of multimedia content 11. This insertion module 11 comprises a graphical user interface 111 making it possible [to display] to display the multimedia content capable of being inserted into the communication and elements for interaction with the user. This interface 111 also interacts with the graphical interface of an instant messaging system (IMS), such as Windows LiveMessenger 12 (registered trade marks) or YahooMessenger 13 (registered trade marks). The insertion module 11 also comprises a protocol analysis block 112 which makes it possible to detect, at the level of the operating system of the device 10, events relating to the computerized communication system by instant messaging, in particular by analysis of the incoming and outgoing data packets. The graphical interface 111 and the protocol analysis module 112 are managed by a control module 113. This control module 113 interacts directly with the core module(s) 14 of the operating system of the device 10 which interact with the IMS 12 and 13. The control module 113 also makes it possible to inject, into the messages exchanged during the communication, data relating to the multimedia content and/or to the execution of the multimedia content. The module 113 also interacts with modules 15 managing the communications network, such as the “Win32.Winsock”, which are called by the IMS 12 and 13 during the computerized communication by IM and which manage the data carrying protocol layers, such as the Transmission Control Protocol (TCP), for example.

FIG. 1 a shows a screenshot of the user interface 111 of the insertion module 11 and the user interface 12 of an instant messaging client such as Windows LiveMessenger (registered trade marks). The user interface 111 of the insertion module 11 comprises several display areas, including:
an area 114 presenting a list of multimedia content. This list can be organised under several headings, such as a heading “My IM” comprising a list of the content belonging to the service user and a heading “Search” allowing the user to perform a search of multimedia content based for example on keywords. Each of the headings is selected using tabs 115. Moreover, each heading can comprise several categories, such as a “Top !” category comprising a list of the most used content, a “New !” category comprising a list of new content, a “My Favorite !” category comprising a list of preferred content, etc., each category being capable of being displayed using buttons 116, and
an area 117 for previewing content using control buttons 118.

The user interface 12 of the instant messaging client comprises a composition window 17 allowing the user to compose messages and a display window 18 for the messages exchanged between the user and his correspondent(s). When a multimedia content is executed on a computerized device on which the insertion module 11 is present, a multimedia content display window 19 is automatically displayed. In the example of FIG. 1a, this content display window 19 is located substantially over the message display window 18. When the execution of the multimedia content is complete, the content display window 19 is closed automatically.

The user interface 111 of the insertion module 11 is as it were “magnetic” and sticks to the user interface 12 of the instant messaging client in use.

FIG. 2 is a functional representation of the insertion service 20 in a preferred embodiment of the invention. In this preferred embodiment, the computerized communication by IM takes place between a first user 21a and a second user 21b respectively on a first device 10a and a second device 10b. In this embodiment the two computerized devices 10a and 10b are each equipped with a multimedia content insertion module, respectively 11a and 11b (“Iminent DesktopEngine”) such as described above. On each of the computerized devices 10a and 10b, an instant messaging client 22a and 22b is active and a messaging session is open. The instant messaging client modules 22a and 22b of these two devices 10a and 10b communicate with a remote instant messaging server 23 implementing the instant messaging service (“IM Service”), in general according to a proprietary protocol. The modules 11a and 11b are connected to a remote server 24 comprising multimedia content storage means 25 (“Content Repository”) and means 26 for transferring the multimedia content to the computerized devices 10a and 10b. The multimedia content is executed in the devices 10a and 10b by players (“Player”), respectively 27a and 27b, the activation of which is controlled by the insertion modules, respectively 11a and 11b. As described above, each insertion module 11a and 11b comprises a protocol analysis block 112 making it possible to intercept and identify the protocol used by the IMS. Each insertion module 11a and 11b also comprises a control module 113 making it possible to inject data into the messages sent during the communication, or to extract data from the messages received.

FIG. 3 is a diagrammatic representation in the form of a time diagram of a sequence of insertion of a multimedia content into a computerized communication by IM in the embodiment shown in FIG. 2. The different operations which take place during a communication between the users 21a and 21b are shown in FIG. 3 in the form of arrows indicating the direction of the operation. The operations are shown in chronological order from the top down. The sequence is described below;
301: the user 21a enters his identifier (“Login”) and password on his IM client 22a located on the computerized device 10a;
302: the IM client 22a of the user 21a connects to the server 23 with the entered identifier and password;
303: the insertion module 11a of the user 21a connects to the server 24 comprising the multimedia content and the content insertion service (“Content Delivery Service”):
304: the user 21a activates, on his IM client 22a, the start of a conversation with the user 21b;
305: the IM client 22a of the user 21a activates the opening of a conversation session with the IM server 23;
306: the IM server 23 sends an invitation to the IM client 22b of the user 21b located on the device 10b,
307: the IM server 23 signals to the IM client 22a of the user 21a that the conversation can start;
308: the insertion module 11a of the user 21a detects, by analysis of the data exchanged between the IM client 22a of this user 11a and the IM server 23, the opening of an active conversation with the user 21b;
309: the insertion module 11a of the user 21a sends a “HI” message in order to verify that the device 10b of the user 21b comprises an insertion module. This “HI” message is sent to the IM server 23 which understands it to be a message sent to it by the IM client 22a of the user 21a and that it must transmit to the IM client 22b of the user 21b;
310: the IM server 23 transmits the “HI” message to the IM client 22b of the user 21b;
311: the “HI” message is intercepted by the insertion module 11b of the user 21b;
312: the insertion module 11b of the user 21b signals its presence by sending an “ACK HI” message to the IM server 23. This “ACK HI” message is sent to the IM server 23 which understands it to be a message which is sent to it by the IM client 22b of the user 21b and that it must transmit to the IM client 22a of the user 21a;
313: the IM server 23 transmits the message “ACK HI” to the IM client 22a of the user 21a;
314: the “ACK HI” message is intercepted by the insertion module 11a of the user 21a. An example of the content of the “ACK HI” message is given below:

```
Content-Type: application/x-iminent-message
<?xml version=“1.0”?>
<msg xmlns:xsi=
“http://www.w3.org/2001/XMLSchema-instance”
xmlns:xsd=“http://www.w3.org/2001/XMLSchema”
xmlns=“http://www.iminent.com”>
  <actions>
    <act xsi:type=“HandAction”
Id=“dfb61e5f-cecc-4868-8ea4-126cfe07c844”
IdentityValue=“na” />
  </actions>
</msg>
```

315: the user 21a chooses a multimedia emovid using the graphical interface of the insertion module 11a;
316: the insertion module 11a of the user 21a obtains the execution initiation data of the emovid selected by the user 21a from the remote server 24 by a “getObjectInfos” function;
317: the insertion module 11a of the user 21a identifies, by a “getActiveConversation” function, the active conversation into which the selected emovid will be inserted;
318: the insertion module 11a of the user 21a sends to the server MI 23 a text message, “Text Message with URL” containing a URL data item linking to the selected emovid, allowing the user 21b to see the emovid;
319: the module 11a of the user 21a [sends] sends a “hidden action” type command to the IM server 23, for example in the format below:

```
MIME-Version: 1.0
Content-Type: application/x-iminent-message
<?xml version=“1.0”?>
<msg xmlns:xsi=“http://www.w3.org/2001/XMLSchema-instance”
xmlns:xsd=“http://www.w3.org/2001/XMLSchema”
xmlns=“http://www.iminent.com”>
  <actions>
    <act xsi:type=“ObjectAction”
Id=“dfb61e5f-cecc-4868-8ea4-126cfe07c844”
IdentityValue=“intranquille@hotmail.com”
ObjectTypeId=“2”
ObjectId=“d6d30d99-36d6-4e41-9e26-fa4cea0cd33c” />
  </actions>
</msg>
```

320: the insertion module 11a of the user 21a activates the execution of the emovid on decoding of the message 319 in the first computerized device 10a using the execution initiation data. For this, the insertion module 11a loads a player (for example “Flash”) which plays the emovid, for example in or over the conversation window of the IM client 22a;
321: the IM server 23 transmits to the IM client 22b of the user 21b the “hidden action” type command and the text message containing the URL;
322: the insertion module 11b of the user 21b intercepts the “hidden action” type command;
323: the insertion module 11b of the user 21b uses this URL in order to obtain the execution initiation data of the emovid selected by the user 21a, from the remote server 24 by a “getObjectInfos” function;
324: the insertion module 11b of the user activates the execution of the emovid in the second device 10b, using the execution initiation data. For this, the insertion module 11b loads a multimedia player, for example “Flash Player”, which plays the emovid in the conversation window of the IM client 22b;

In this configuration the emovid is executed automatically on the device 10a and on the device 10b. The execution of the emovid on the devices 10a and 10b is activated by the selection of an emovid by the user 21a.

Once constituted, the emovids are stored in the storage means 25 of the remote insertion server 24 by the user 21a or the user 21b, or by another user of the messaging service subscribed to the insertion service.

FIG. 4 shows a second embodiment of the invention, in which the communication also takes place between the first user 21a and the second user 21b, respectively on a first device 10a and a second device 10b. In this embodiment, only the device 10a of the user 21a is equipped with the multimedia content insertion module 11a, (“Iminent DesktopEngine”) as described above. The other elements of the configuration are as described for FIG. 2.

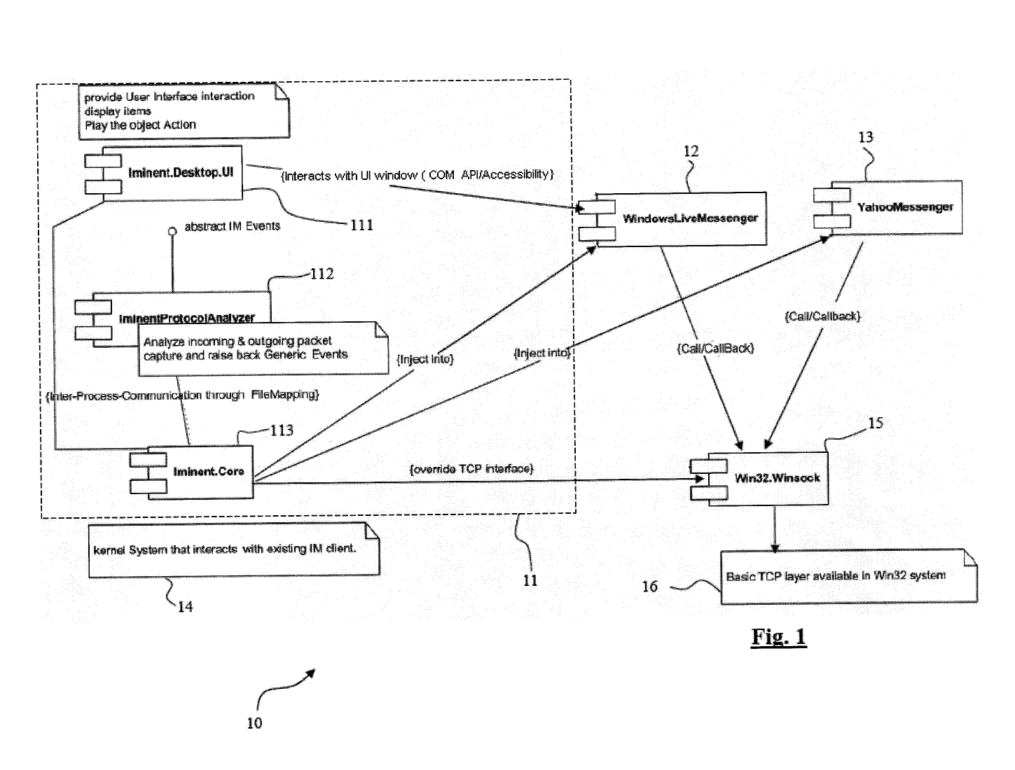

FIG. 5 is a diagrammatic representation in the form of a time diagram of a sequence of insertion of a multimedia content into a computerized communication by IM in the second embodiment. The different operations which take place during a communication between the users 21a and 21b are shown in FIG. 0 in the form of arrows indicating the direction of the operation. The sequence is described below;
401: the user 21a activates, on his IM client 22a, the start of a conversation with the user 21b;
402: the IM client 22a of the user 21a activates the opening of a conversation session with the MI server 23;
403: the MI server 23 sends an invitation to the IM client 22b of the user 21b located on the device 10b,
404: the MI server 23 signals to the IM client 22a of the user 21a that the conversation can start;
405: the insertion module 11a of the user 21a detects, by analysis of the data exchanged between the IM client 22a of this user 11a and the IM server 23, the opening of an active conversation with the user 21b;
406: the insertion module 11a of the user 21a sends a “HI” message in order to verify that the device 10b of the user 21b comprises an insertion module. This “HI” message is sent to the IM server 23 which understands it as a message which is sent to it by the IM client 22a of the user 21a and that it must transmit to the IM client 22b of the user 21b;
407: the IM server 23 transmits the “HI” message to the IM client 22b of the user 21b; As the device 10b of the user 21b has no insertion module, there is no “ACK HI” response as described in the case of the preferred embodiment 20 shown in FIG. 2.
408: the user 21a chooses a multimedia emovid using the graphical interface of the insertion module 11a;
409: the insertion module 11a of the user 21a obtains the execution initiation data of the emovid selected by the user 21a from the remote server 24 by a “getObjectInfos” function;
410: the insertion module 11a of the user 21a identifies, by a “getActiveConversation” function, the active conversation into which the selected emovid will be inserted;
411: the module 11a of the user 21a sends a “hidden action” type command to the IM server 23;
412: the insertion module 11a of the user 21a sends to the IM server 23 a text message containing a link to the selected emovid in the form for example of a URL;
413: the IM server 23 sends the text message containing the link to the IM client module 22b of the user 21b. The link is displayed in the conversation window of the IM client 22b;
414: the insertion module 11a of the user activates the execution of the emovid using the execution initiation data. For this, the insertion module 11a loads a player (for example “Flash Player”) which plays the emovid, for example in or over the conversation window of the IM client 22a;
415: the user uses the link contained in the text message to access an internet page using an internet browser, and executes the emovid. This access can be done automatically by the IM client 22b if the link contains a command or an automatic execution parameter. This access can also be done manually, simply by the user 21b clicking on the link in question, once the latter is displayed in the conversation window of the IM client 22b.
416: the emovid is executed on the device 10b of the client 221b.

In the embodiments described here, the multimedia content insertion service is implemented in the form of an additional service developed by the company IMINENT, offered to the users of an existing instant messaging system, with no or few modifications to be made to the software configuration installed for this messaging system.

This service is implemented from one or more servers accessible over the internet, which alone or in multiples provide the “third computerized device” mentioned above. These services rely on a software support environment (“backoffice framework”) which provides management of the content and the identified users, and a front end part which is accessible over the world wide web, making it possible to offer the contents and uses originating from the services.

From a technical point of view, the infrastructure of the IMINENT services is of the SOA (Service Oriented Architecture) type, making it possible in particular to make third parties a proposal for development, then publication, of a set of services supplementary to the IMINENT desktop application forming the user interface, on top of the layers of interaction with the instant messaging networks.

The native exchanges are carried out in XML format between the different system components, promoting its interoperability with applications produced or installed by third parties.

The solution as a whole is constructed on the Microsoft .NET architecture in “web services” mode, based on the object-oriented languages C# and C++.

In addition to user-created content, the service offers media elements which can be developed by IMINENT or by other actors. Preferably the accessible content is fully or partially integrated into an infrastructure combining “Flash 9.0” and “Flex”, which allows the integration of SOA services via XML and gives the ability to offer original interactive media.

Moreover, the recent optimization of the “Flash” format makes it possible to dispense with the costly installation of proprietary caching and video streaming, while retaining a pleasant client experience when viewing large visual items.

As regards the client station application, IMINENT relies on native access techniques in unmanaged code, using WIN32, VISTA and WINFX APIs such as GlobalAPIHooking and SystemHooking.

Of course, the invention is not limited to the examples of applications and embodiments described above. It can for example form an integral part of a messaging service, the insertion module then being incorporated into the instant messaging client.

Moreover it can be implemented in the case of a communication by instant messaging in which more than two users participate.

1. A method for the insertion of a multimedia content into a computerized communication by an instant messaging service between a first session executed on a first computerized device and at least one second session executed on a second computerized device, said method comprising on the one hand, prior to said insertion of the multimedia content, the following steps:
said multimedia content is constituted by at least one instant messaging user;
said multimedia content is stored in a third computerized device,
and on the other hand, during said communication, the following steps:
the execution of said content is activated by the first session;
said multimedia content is automatically executed, following said activation, based on data received from said third computerized device.

2. The method according to claim 1, characterized in that the automatic execution of the multimedia content takes place in the first computerized equipment.

3. The method according to claim 1, characterized in that the automatic execution of the multimedia content takes place in the second computerized equipment.

4. The method according to claim 1, characterized in that it comprises the sending by the first computerized device to the second computerized device of initiation data of execution of the multimedia content, said execution initiation data comprising a data item of the Uniform Resource Locator (URL) type, comprising an address of an internet-type page, provided for the execution of the multimedia content.

5. The method according to claim 4, characterized in that the multimedia content is executed automatically in the second computerized device when it accesses the internet page.

6. The method according to claim 1, characterized in that it comprises moreover an insertion into at least one message in the communication, of data related to the multimedia content and/or the execution of the multimedia content.

7. The method according to claim 1, characterized in that it comprises moreover a selection, by a user in the first equipment, of multimedia content from a plurality of multimedia contents.

8. The method according to claim 1, characterized in that it comprises an automatic offer of at least one multimedia content to be inserted in the communication, chosen according to an analysis of the content of at least one message during the current communication and/or at least one previous communication.

9. The method according to claim 1, characterized in that it comprises moreover an identification of a type of instant messaging service by analysis of the technical data of the communication.

10. The method according to claim 1, characterized in that it is implemented for the insertion of a multimedia content into a computerized communication by an instant messaging service between the first session executed on the first computerized device and several sessions each executed on a computerized device.

11. The method of instant messaging implementing a method for the insertion of a multimedia content according to claim 1.

12. A system for the insertion of a multimedia content into a computerized communication by instant messaging between a first session executed on a first computerized device and a second session executed on a second computerized device, said system comprising:
means of constituting said multimedia content by at least one instant messaging user;
means of storing said multimedia content in a third computerized device;
computerized means of activating the execution of said content, by the first session, during said communication; and
means of executing said multimedia content automatically, following said activation, from data received from said third computerized device.

13. The system according to claim 12, characterized in that it comprises means of analysis provided for analyzing the content of at least one message in the communication in order to choose at least one multimedia content according to said content.

14. The system according to claim 12, characterized in that it also comprises means of detection provided for identifying the type of instant messaging service.

15. The system according to claim 12, characterized in that it comprises moreover means of display, at least by the first computerized device, of a list of previously-stored multimedia content on the third equipment.

16. An instant messaging system incorporating the system according to claim 12.
